(19) United States
(12) Patent Application Publication
(10) Pub. No.: US 2012/0016794 A1
(43) Pub. Date: Jan. 19, 2012

(54) Real-Time Gifting Using a Computing device and Social Media

(76) Inventors: Rick N. Orr, Austin, TX (US); David G. Lemley, Cedar Park, TX (US); Cameron Hotchkies, Austin, TX (US); C. Kelly Harper, Austin, TX (US)

(21) Appl. No.: 13/184,472

(22) Filed: Jul. 15, 2011

Related U.S. Application Data
(60) Provisional application No. 61/399,634, filed on Jul. 15, 2010.

(51) Int. Cl. G06Q 40/00

(52) U.S. Cl. 705/39; 705/319

(57) ABSTRACT

A user of a social network can open a tab at a business (e.g., a bar or restaurant) and can provide a message to other users of the social network, to which the user is socially coupled, to join the user at the business. The message to the other users can include an account identification that the other users can use applying money to the tab or in purchasing a good or service, for sale by the business, for the user. One or more of the other users can be present at the business to purchase a good or service for the user, and/or one or more of the other users may not be present at the business to purchase a good or service for the user. For example, one or more of the other users can purchase a good or service for the user from a remote location.

### BACKGROUND

This application claims benefit of U.S. Provisional Application Ser. No. 61/399,634, filed Jul. 15, 2010, titled “Real-time gift using a mobile phone and social media”, which application is hereby incorporated by reference in its entirety as though fully and completely set forth herein.

1. Technical Field

This disclosure relates generally to the field of users of social networks, and, more specifically, this disclosure pertains to the field of one or more users of a social network providing a payment to an account with a business.

2. Description of the Related Art

In the past, users of a social network could post messages to other users of the social network. For example, a message could convey that a first user was going to be at a business establishment and that other users were welcome to join the first user. This can leave-out at least a second user of the other users if the second user is not able to attend at the location or at the time.

### BRIEF DESCRIPTION OF THE DRAWINGS

The preferred embodiment(s) will become apparent upon reading the following detailed description and upon reference to the accompanying drawings in which:

FIG. 1 provides a block diagram of one or more network communications systems, according to one or more embodiments;

FIG. 2 provides another block diagram of one or more network communications systems, according to one or more embodiments;

FIG. 3 provides a block diagram of a mobile device, according to one or more embodiment;

FIG. 4 provides a block diagram of a computing device, according to one or more embodiments;

FIGS. 5A and 5B provide exemplary sequence diagrams, according to one or more embodiments;

FIGS. 6A and 6B illustrate a method of operating a coordination computing device, according to one or more embodiments;

FIG. 7 illustrates an exemplary block diagram of a mobile device and a display window or display area of a mobile device application, according to one or more embodiments; and

FIGS. 8-13 provide exemplary block diagrams of various user interfaces of a mobile device application, according to one or more embodiments.

While the described embodiments may be susceptible to various modifications and alternative forms, specific embodiments thereof are shown by way of example in the drawings and will herein be described in detail. It should be understood, however, that the drawings and detailed description thereto are not intended to limit the disclosure to the particular form disclosed, but on the contrary, the disclosure is to cover all modifications, equivalents and alternatives falling within the spirit and scope of an invention as defined by appended claims.

### DETAILED DESCRIPTION

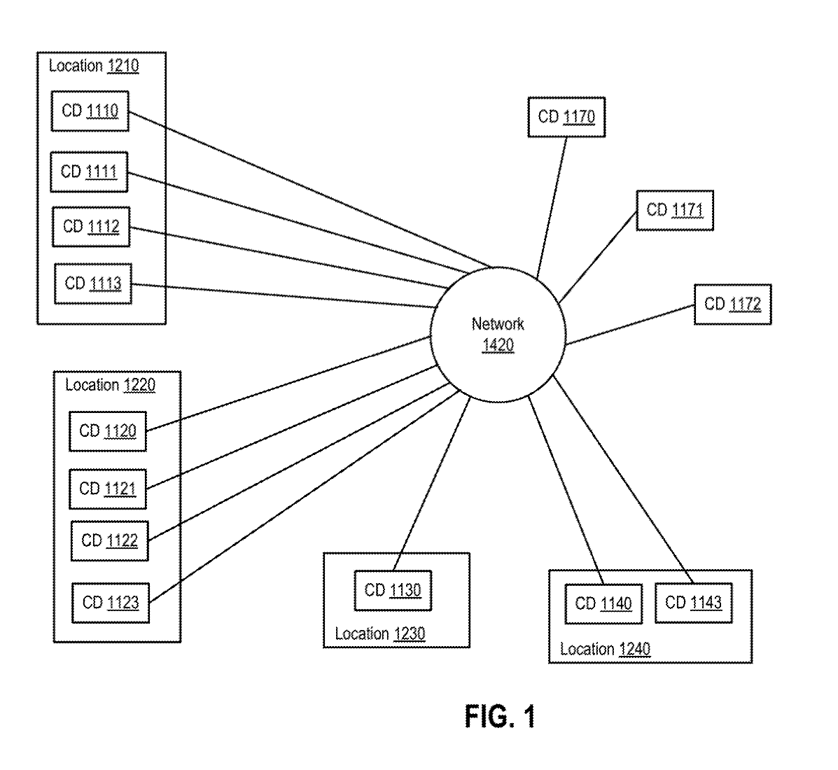

Turning now to FIG. 1, a block diagram of one or more network communications systems is illustrated, according to one or more embodiments. As shown, one or more computing devices (CDs) 1110-1170 can be coupled to a network 1420. In one or more embodiments, network 1420 can include a wired network, a wireless network or a combination of wired and wireless networks. In one example, network 1420 can be coupled to one or more communications networks such as one or more of a local area network (LAN), a wireless LAN (WLAN), a private wide area network (WAN), a public WAN (e.g., an Internet), a wireless WAN (WWAN), a public switched telephone network (PSTN), and a mobile telephone network (MTN), among others. In another example, network 1420 can include one or more communications networks such as one or more of a LAN, a WLAN, a private WAN, a public WAN (e.g., an Internet), a WWAN, a PSTN, and a MTN, among others. In one or more embodiments, network 1420 can form part of a private WAN and/or a public WAN (e.g., an Internet).

As illustrated, CDs 1110-1113 can be at a location 1210, CDs 1120-1123 can be at a location 1220, computing device (CD) 1130 can be at a location 1230, and CDs 1140 and 1143 can be at a location 1240. In one or more embodiments, locations 1210-1240 can include one or more of bars, restaurants, hotels, geographic regions, shops, retail establishments, coffee shops, offices, homes, automobiles, and airports, among others. In one or more embodiments, a CD of CDs 1110-1172 can be any of various types of devices that include a processor coupled to a memory medium, and a CD can be broadly defined as any device that includes a processor that can execute instructions from a memory medium. In one example, CD 1110 can be any of various types of devices, including a computer system, such as a portable computer, a personal digital assistant (PDA), a tablet computing device, a mobile telephone (e.g., a cellular telephone, a satellite telephone, etc.), a wearable computing device, a portable Internet appliance, a communications device, a handheld mobile computing device, or other mobile wireless device. In another example, CD 1170 can include a computer system, a group of computer systems, a cluster of computer system, a server computer system, an Internet appliance, or other wired or wireless device.

In one example, one or more of CDs 1110-1112, 1120-1122, 1130, and 1140 can be operated by respective one or more users of a social network (e.g., Facebook, Twitter, MySpace, Foursquare, etc.). In one instance, location 1210 can include a bar, and a user of CD 1110 can open a tab (e.g., an account) at the bar and can provide a message to one or more others users of the social network, to which the user is socially coupled, indicating that the user is at the bar and has opened a tab. For example, the message can include text such as, “It's happy hour! Come join me at Dave's Bar.”, “I have a case of the Mondays X-(Meet me at Flingers.”, “We just sold our one millionth widget! Come join me at Dave's Bar.”, etc.

In a second instance, location 1220 can include a restaurant, and a user of CD 1120 can open a ticket (e.g., an account) at the restaurant and can provide a message to one or more others users of the social network, to which the user is socially coupled, indicating that the user is at the restaurant and has opened a ticket at the restaurant. For example, the message can include text such as, “It's my birthday! Come join me at Highland Grill.”, “We just sold our one millionth widget! Come join me at Highland Grill.”, etc. In a another instance, location 1240 can include a hotel, and a user of CD 1140 can open a ticket (e.g., an account) at the hotel and can provide a message to one or more others users of the social network, to which the user is socially coupled, indicating that the user is at the hotel and has opened a ticket at the hotel. For example, the message can include text such as, “I'm on vacation! Come join me at the Pelican Hotel.” “, “I'm in Austin! Come join me at the Pelican Hotel.”, etc.

In a second example, a user of CD 1130 at location 1230 can provide a good and/or service to one or more of the user of CD 1110, the user of CD 1120, and the user of CD 1140. In a third example, a user of CD 1111 at location 1210 can provide a good and/or a service to one or more of the user of CD 1110, the user of CD 1120, and CD 1140. For instance, the user of CD 1130 can be socially coupled, via the social network, to one or more of the user of CD 1110, the user of CD 1120, and the user of CD 1140, and the good and/or the service can be provided by a business associated with the location of the respective CD. For example, the user of CD 1130 or the user of CD 1111 can purchase a drink for the user of CD 1110, can purchase a desert for the user of CD 1120, and/or can purchase a massage for the user of CD 1140.

In one or more embodiments, one or more of CDs 1113, 1123, and 1143 can include one or more structures and/or include one or more functionalities of a point of sale (POS) terminal and/or a property management system (e.g., a property management system at a hotel that provides accounting services for guest accounts with the hotel). In one example, the user of CD 1130 or the user of CD 1111 can purchase a drink for the user of CD 1110 via CD 1170 (e.g., a coordination server) and via CD 1113 which can be utilized by the bar to manage tabs of customers of the bar. In a second example, the user of CD 1130 or the user of CD 1111 can purchase a desert for the user of CD 1120 via CD 1170 and via CD 1123 which can be utilized by the restaurant to manage tickets of customers of the restaurant. In a third example, the user of CD 1130 or the user of CD 1111 can purchase a massage for the user of CD 1140 via CD 1170 and via CD 1143 which can be utilized by the hotel to manage accounts of customers of the hotel.

In one or more embodiments, CD 1170 can function as a CD of coordination system (e.g., a server of the coordination system). For example, the coordination server can coordinate messages and/or payments between and/or among two or more users of a social network, as described herein. For instance, CD 1170 can receive information from a POS terminal and/or a property management system (PMS) indicating a creation of an account associated with a user of a social network, receive a message from a user of the social network indicating that the user of the social network has a tab/ticket/bill with a bar/restaurant/hotel, provide the message to social network, receive payment information associated with another user of the social network to purchase a good/service from the bar/restaurant/hotel for the user, and provide the payment information (e.g., a good/service to purchase and a credit card number) to the bar/restaurant/hotel.

In one or more embodiments, CD 1171 can function as a CD of a social network. For example, CD 1171 can receive a message (e.g., “It's happy hour! Come join me at Dave's Bar.”) from a user of the social network, provided via CDs 1110 and 1170, and can provide the message to one or more other users of the social network to which the user is socially coupled. In one or more embodiments, CD 1172 can function as a CD of another social network and can include one or more same or similar structures and/or functionalities of CD 1171. For example, the user of CD 1110 can be a user of multiple social networks, and CD 1170 can communicate with one or more of CDs 1171 and 1172.

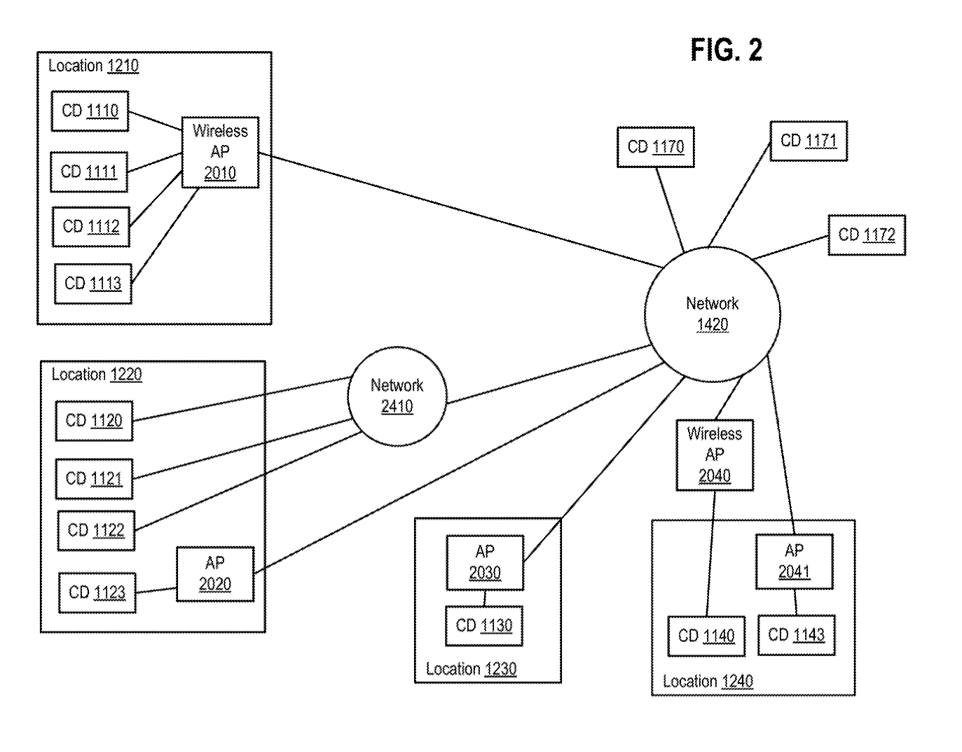

Turning now to FIG. 2, another block diagram of one or more network communications systems is illustrated, according to one or more embodiments. As shown, one or more of CDs 1110-1113 can be coupled to a wireless access point (AP) 2010 that can be coupled to network 1420. For example, wireless AP 2010 can wirelessly communicate with one or more of CDs 1110-1113 utilizing one or more methods, procedures, protocols, and/or structures described with reference to Institute of Electrical and Electronics Engineers (IEEE) 802.11. In one instance, wireless AP 2010 can implement a WLAN. In a second instance, wireless AP 2010 can be or include a wireless Ethernet AP. In another instance, wireless AP 2010 can be or include a Wi-Fi AP.

As illustrated, one or more of CDs 1120-1122 can be coupled to a network 2410 that can be coupled to network 1420. In one or more embodiments, network 2410 can be, include, or form part of a mobile telephone network (MTN). In one example, network 2410 can be, be coupled to, include, or form part of a telephony network that can include a wireless satellite telecommunications network and/or a wireless cellular telecommunications network. In a second example, network 2410 can support and/or implement one or more of GSM (global system for mobile communications), CDMA (code division multiple access), TDMA (time division multiple access), and FDMA (frequency division multiple access), enhanced data rates for GSM evolution (EDGE), General Packet Radio Service (GPRS), and long term evolution (LTE), among others. In one or more embodiments, network 2410 can communicate information such as data and/or voice.

As shown, CD 1123 can be coupled to an AP 2020 that can be coupled to network 1420. In one or more embodiments, AP 2020 can be a wired AP. For example, CD 1123 can be coupled to AP 2020 via a wired serial connection (e.g., wired Ethernet, RS-232, universal serial bus, IEEE 1394, etc.). In one instance, AP 2020 can be or include a router. In another instance, AP 2020 can be or include a modem (e.g., a PSTN modem, a cable modem, a digital subscriber line modem, etc.).

As illustrated, CD 1130 can be coupled to an AP 2030 that can be coupled to network 1420. In one or more embodiments, AP 2030 can be a wired AP. For example, CD 1130 can be coupled to AP 2030 via a wired serial connection (e.g., wired Ethernet, RS-232, universal serial bus, IEEE 1394, etc.). In one instance, AP 2030 can be or include a router. In another instance, AP 2030 can be or include a modem (e.g., a PSTN modem, a cable modem, a digital subscriber line modem, etc.). In one or more embodiments, a wireless AP can be coupled to AP 2030 that can allow CD 1130 to communicate with AP 2030 in a wireless fashion. For example, the wireless AP can interpose CD 1130 and AP 2030 such that communications between CD 1130 and AP 2030 occur via the wireless AP.

As shown, CD 1140 can be coupled to a wireless AP 2040 that can be coupled to network 1420. For example, wireless AP 2040 can wirelessly communicate with CD 1140 utilizing one or more methods, procedures, protocols, and/or structures described with reference to IEEE 802.16. For instance, wireless AP 2040 can be or include a Wi-Max AP. As illustrated, CD 1143 can be coupled to AP 2041 that can be coupled to network 1420. In one or more embodiments, AP 2041 can be a wired AP. For example, CD 1143 can be coupled to AP 2041 via a wired serial connection (e.g., wired Ethernet, RS-232, universal serial bus, IEEE 1394, etc.). In one instance, AP 2041 can be or include a router. In another instance, AP 2041 can be or include a modem (e.g., a PSTN modem, a cable modem, a digital subscriber line modem, etc.). In one or more embodiments, a wireless AP can be coupled to AP 2041 that can allow CD 1143 to communicate with AP 2041 in a wireless fashion. For example, the wireless AP can interpose CD 1143 and AP 2041 such that communications between CD 1143 and AP 2041 occur via the wireless AP.

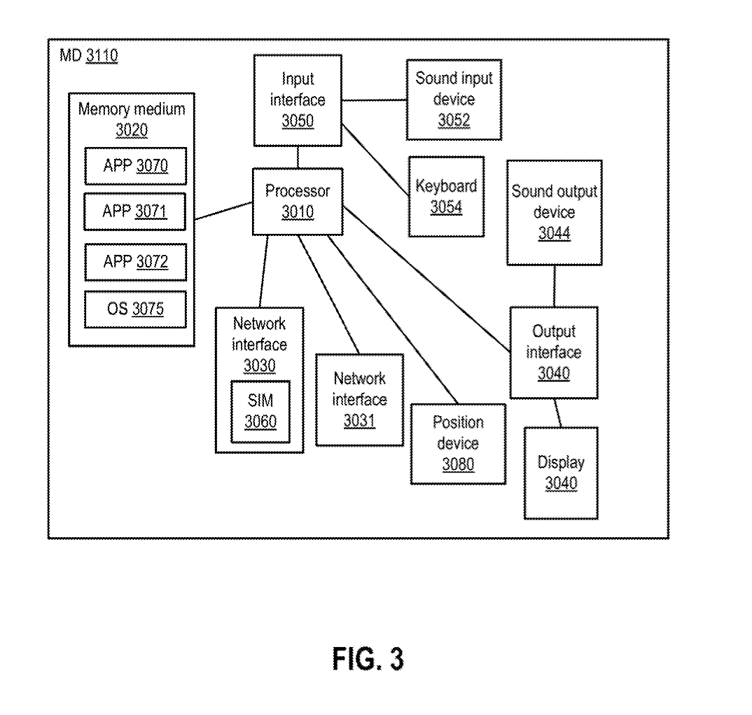

Turning now to FIG. 3, a block diagram of a mobile device is illustrated, according to one or more embodiments. In one or more embodiments, a mobile device (MD) 3110 can be any of various types of devices, including a computer system, such as a portable computer, a PDA, a tablet computing device, a mobile telephone (e.g., a cellular telephone, a satellite telephone, etc.), a wearable computing device, a portable Internet appliance, a communications device, a handheld mobile computing device, or other mobile wireless device. As shown, MD 3110 can include a memory medium 3020 coupled to a processor 3010.

In one or more embodiments, processor 3010 can include one or more cores, and each core of processor 3010 can implement an instruction set architecture (ISA). For example, each of one or more of applications (APPs) 3070-3072 and an operating system (OS) 3070, stored in memory medium 3020, can include a set of instructions of the ISA that can be executed by processor 3010 to implement one or more methods, processes, and/or systems described herein. As illustrated, MD 3110 can include network interfaces 3030 and 3031, a user output interface 3040, a user input interface 3050, and a position device 3080 coupled to processor 3010.

In one or more embodiments, user output interface 3040 can be used to convey information (e.g., text, graphic, video, audio, etc.) to a user of MD 3110. As illustrated, MD 3110 can include a display 3040 (e.g., a display screen) that can be coupled to output interface 3040. Display 3040 can be utilized to convey text, graphic, image, motion picture, and/or video information to a user of MD 3110. As shown, MD 3110 can include a sound output device 3044 (e.g., a device and/or circuitry that can produce one or more sounds such as a speaker) coupled to output interface 3040.

As illustrated, MD 3110 can include a sound input device 3052 coupled to input interface 3050. In one or more embodiments, sound input device 3052 (e.g., a microphone) can be used to receive sounds from a user of MD 3110. As shown, MD 3110 can include a keyboard 3054, coupled to input interface 3050, that can be used to receive user input from a user of MD 3110.

In one or more embodiments, MD 3110 can include one or more sensors, coupled to processor 3010, that can be used to receive user input from a user of MD 3110. For example, the one or more sensors can be coupled to processor 3010 via input interface 3050. In one instance, one or more sensors can include capacitive sensors that can be utilized in determining one or more positions on display 3040 (e.g., a touch screen). In another instance, one or more sensors can include resistive sensors that can be used to determine one or more positions on display screen 3040 (e.g., a touch screen). In one or more embodiments, display 3040 and the one or more sensors can be used in implementing a keyboard. For example, display 3040 can be used to present an image of a keyboard, and the one or more sensors can be utilizing in determining a position of user input on the image of the keyboard to determine a received key of the keyboard.

In one or more embodiments, network interface 3030 can include a transceiver that is operable to communicate information (e.g., data, voice data, etc.) with network 2410. For example, network interface 3030 can be utilized in communicating with one or more of a satellite, a base transceiver station, and a Node B included in and/or coupled to network 2410. As illustrated, network interface 3030 can include a subscriber identity module (SIM) 3060. In one or more embodiments, SIM 3060 can store an IMSI (international mobile subscriber identity) that can include a unique number and/or identity associated with a GSM network and/or a UMTS (universal mobile telecommunications system) network. For example, unique number and/or identity can include a MSISDN (mobile subscriber ISDN (integrated services digital network)) number, mobile station international ISDN number(s), or mobile international ISDN number, among others. For example, the MSISDN can include a telephone number corresponding to SIM 3060.

In one or more embodiments, network interface 3031 can be utilized in communicating with a wireless AP (e.g., wireless AP 2010, wireless AP 2040, etc.). In one example, network interface 3031 can include a transceiver that is configured to communicate information with wireless AP 2010. For instance, network interface 3031 can be configured to implement one or more methods, procedures, protocols, and/or structures described with reference to IEEE 802.11. In a second example, network interface 3031 can include a transceiver that is configured to communicate information with wireless AP 2040. For instance, network interface 3031 can be configured to implement one or more methods, procedures, protocols, and/or structures described with reference to IEEE 802.16.

In one or more embodiments, MD 3110 can include a position device 3080 coupled to processor 3010. In one example, position device 5080 can include a GPS (global positioning system) receiver and/or device. In one or more embodiments, position device 3080 can provide one or more one or more of positioning information, heading information, and timing information to processor 3010. For example, position device 3080 can provide one or more of latitude information, longitude information, and altitude information, among others, to processor 3010. In one or more embodiments, one or more of CDs 1110-1112, 1120-1122, and 1140 can include one or more same or similar structures and/or functionalities as those described with reference to MD 3110.

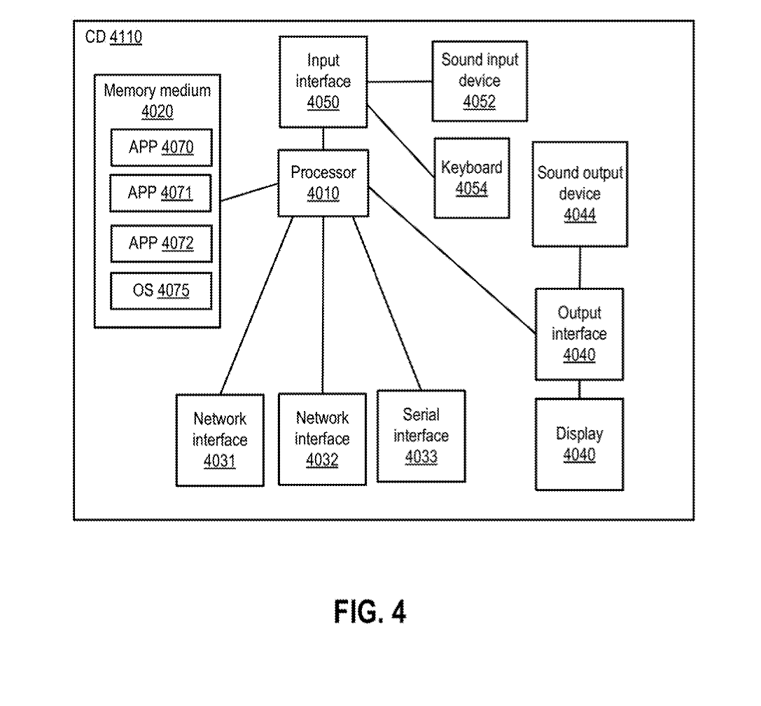

Turning now to FIG. 4, a block diagram of a computing device is illustrated, according to one or more embodiments. In one or more embodiments, CD 4110 can be any of various types of devices, including a computer system, such as a portable computer, a desktop computer, a POS terminal, an Internet appliance, or other wired or wireless device. As shown, a CD 4110 can include a memory medium 4020 coupled to a processor 4010. In one or more embodiments, processor 4010 can include one or more cores, and each core of processor 4010 can implement an ISA. For example, each of one or more of APPs 4070-4072 and an OS 4070, stored in memory medium 4020, can include a set of instructions of the ISA that can be executed by processor 4010 to implement one or more methods, processes, and/or systems described herein. As illustrated, CD 4110 can include network interfaces 4031 and 4032, a serial interface 4033, a user output interface 4040, and a user input interface 4050 coupled to processor 4010.

In one or more embodiments, user output interface 4040 can be used to convey information (e.g., text, graphic, video, audio, etc.) to a user of CD 4110. As illustrated, CD 4110 can include a display 4040 (e.g., a display screen) that can be coupled to output interface 4040. Display 4040 can be utilized to convey text, graphic, image, motion picture, and/or video information to a user of CD 4110. As shown, CD 4110 can include a sound output device 4044 (e.g., a device and/or circuitry that can produce one or more sounds such as a speaker) coupled to output interface 4040.

As illustrated, CD 4110 can include a sound input device 4052 coupled to input interface 4050. In one or more embodiments, sound input device 4052 (e.g., a microphone) can be used to receive sounds from a user of CD 4110. As shown, CD 4110 can include a keyboard 4054, coupled to input interface 4050, that can be used to receive user input from a user of CD 4110.

In one or more embodiments, CD 4110 can include one or more sensors, coupled to processor 4010, that can be used to receive user input from a user of CD 4110. For example, the one or more sensors can be coupled to processor 4010 via input interface 4050. In one instance, one or more sensors can include capacitive sensors that can be utilized in determining one or more positions on display 4040 (e.g., a touch screen). In another instance, one or more sensors can include resistive sensors that can be used to determine one or more positions on display screen 4040 (e.g., a touch screen). In one or more embodiments, display 4040 and the one or more sensors can be used in implementing a keyboard. For example, display 4040 can be used to present an image of a keyboard, and the one or more sensors can be utilizing in determining a position of user input on the image of the keyboard to determine a received key of the keyboard.

In one or more embodiments, network interface 4031 can be utilized in communicating with a wireless AP (e.g., wireless AP 2010, wireless AP 2040, etc.). In one example, network interface 4031 can include a transceiver that is configured to communicate information with wireless AP 2010. For instance, network interface 4031 can be configured to implement one or more methods, procedures, protocols, and/or structures described with reference to IEEE 802.11. In a second example, network interface 4031 can include a transceiver that is configured to communicate information with wireless AP 2040. For instance, network interface 4031 can be configured to implement one or more methods, procedures, protocols, and/or structures described with reference to IEEE 802.16.

In one or more embodiments, network interface 4032 can be utilized in communicating with an AP (e.g., AP 2020, AP 2030, AP 2041, etc.). In one example, network interface 4032 can include a transceiver that is configured to communicate information with AP 2020. For instance, network interface 4032 can be configured to implement one or more methods, procedures, protocols, and/or structures described with reference to IEEE 802.3 or wired Ethernet.

In one or more embodiments, network interface 4033 can be utilized in communicating with an AP (e.g., AP 2020, AP 2030, AP 2041, etc.). In one example, network interface 4033 can include a transceiver that is configured to communicate information with AP 2020. For instance, network interface 4033 can be configured to implement one or more methods, procedures, protocols, and/or structures to communicate with a serial bus or a serial device. For example, the serial bus or the serial device can communicate using a universal serial bus, an IEEE 1394 serial bus, a RS-232 serial bus, etc.

In one or more embodiments, one or more of CDs 1113, 1123, 1143, and 1170-1172 can include one or more same or similar structures and/or functionalities as those described with reference to CD 4110. In one example, CD 1130 can be a desktop computing system that can include one or more same or similar structures and/or functionalities as those described with reference to CD 4110. In another example, CD 1170 can be a server that can include one or more same or similar structures and/or functionalities as those described with reference to CD 4110.

In one or more embodiments, one or more structures of CD 4110 may not be included in one or more of CDs 1113, 1123, 1143, and 1170-1172. In one example, CD 1130 can be a desktop computing system where one or more of sound input device 4052, keyboard 4054, and display 4040 may not be included in CD 1130. For instance, one or more of sound input device 4052, keyboard 4054, and display 4040 can be external to CD 1130 and coupled to CD 1130. In another example, CD 1170 can be a server computing system where one or more of sound input device 4052, keyboard 4054, and display 4040 may not be included in CD 1170. For instance, one or more of sound input device 4052, keyboard 4054, and display 4040 can be external to CD 1170 and can be coupled to CD 1170.

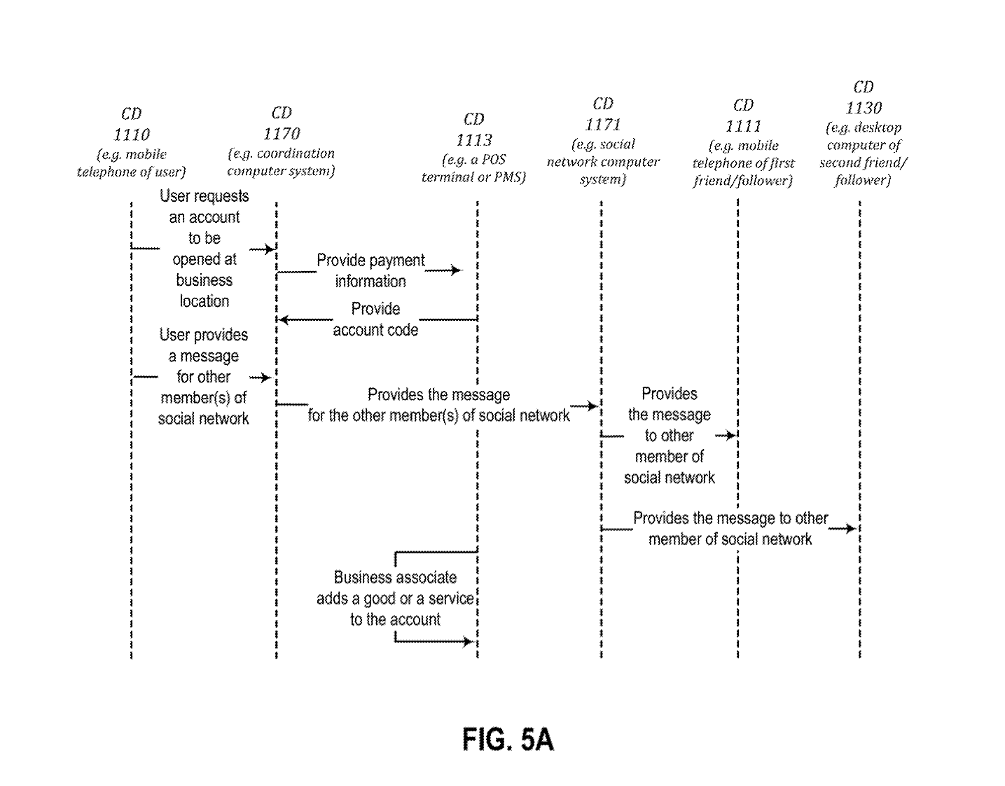

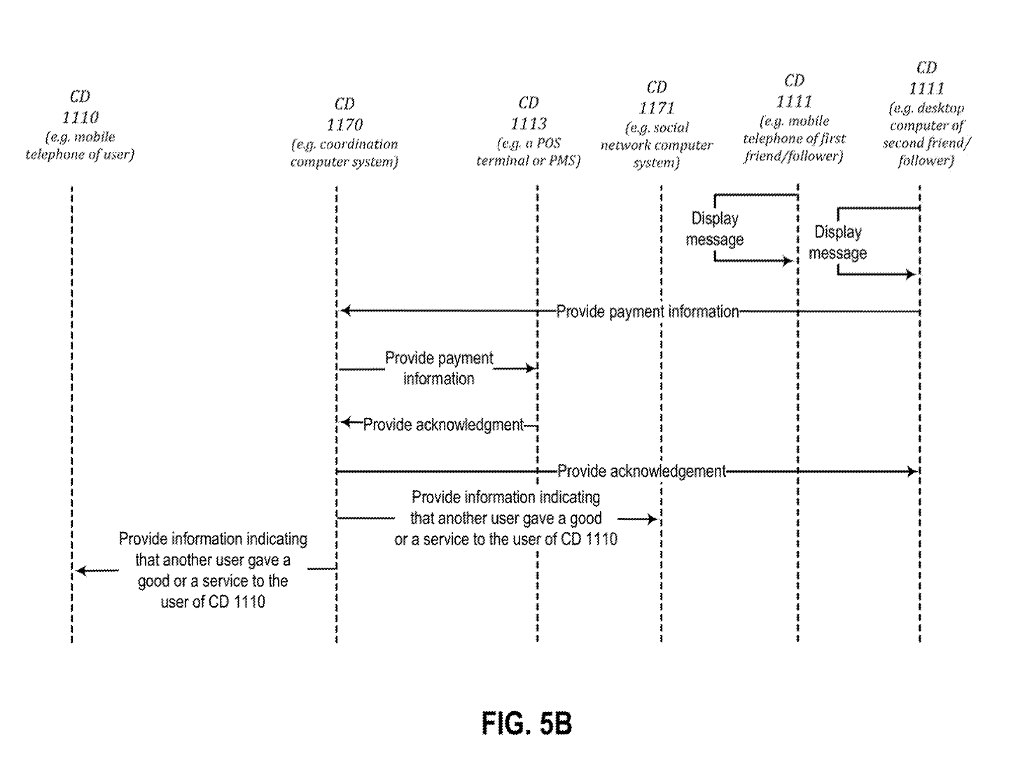

Turning now to FIGS. 5A and 5B, exemplary sequence diagrams are illustrated, according to one or more embodiments. As illustrated in FIG. 5A, a user can request for an account (e.g., a tab, a ticket, etc.) to be opened with a business. In one example, the user can utilize an application (APP) 3070 of CD 1110 (e.g., a mobile telephone of the user) to request that a tab/ticket/bill be opened at a bar/restaurant/hotel. In one or more embodiments, APP 3070 (e.g., a smartphone APP, a tablet computing device APP, a music player APP, etc.) can be an APP that executes to implement one or more methods, procedures, and/or structures described with reference to CD 1110. For instance, APP 3070 can communicate with APP 4070 of CD 1170 (e.g., a coordination computer system) to implement one or more methods, procedures, and/or structures described with reference to CD 1110 and/or CD 1170. In a second example, the user can utilize an APP 3071 of CD 1110 to request that a tab/ticket/bill be opened at a bar/restaurant/hotel. In one or more embodiments, APP 3071 can be a web browser that executes to implement one or more methods, procedures, and/or structures described with reference to CD 1110. For instance, the web browser can communicate with APP 4071 of CD 1171 (e.g., a social network computer system) to implement one or more methods, procedures, and/or structures described with reference to CD 1110 and/or CD 1170.

In one or more embodiments, the request that a tab/ticket/bill be opened at a bar/restaurant/hotel can include one or more of a user identification (ID), authentication information (e.g., a password), and payment information (e.g., a credit card number, a debit card number, a PayPal account number, etc.). In one example, CD 1170 can store payment information (e.g., a credit card number, a debit card number, a PayPal account number, etc.) for later use with a business and after the user is identified and authenticated. As shown, CD 1170 can provide the payment information to CD 1113. For example, CD 1113 can be a POS terminal or other accounting computer system (e.g., a property management system) of a business associated with location 1210. As illustrated, CD 1113 can provide CD 1170 an account identifier that can be used to identify the requested account. For example, the account identifier can include a string of characters that can be input into a keyboard of a POS terminal of the business and/or displayed via a display of CD 1110. In one or more embodiments, the account identifier can include a string of characters and/or an image that can be matched to a button or icon displayed via a display of the POS terminal.

As illustrated, the user of CD 1110 can provide, to CD 1170, a message for one or more other users/members of a social network. For example, the message can include text such as “It's happy hour! Come join me at Dave's Bar.”, “It's my birthday! Come join me at Highland Grill.”, or “I'm in Austin! Come join me at the Pelican Hotel.”, among others. As shown, CD 1170 can provide the message from the user of CD 1110 to CD 1171 (e.g., a CD of the social network).

As shown, CD 1171 can provide the message from the user to the one or more other users/members of the social network. For example, CD 1171 can provide the message from the user to CDs 1111 (e.g., a mobile telephone of a first friend/follower of the user of CD 1110) and 1130 (e.g., a desktop computer of a second friend/follower of the user of CD 1110). In one or more embodiments, the one or more other users/members of the social network can be socially coupled to the user of CD 1110. In one example, the one or more other users/members of the social network can be one or more “friends” (as used in the social network and/or defined by the social network) of the user. For instance, the social network can be Facebook, and the one or more other users/members of Facebook can be one or more “friends” of the user. In a second example, the one or more other users/members of the social network can be one or more “followers” (as used in and/or defined by the social network) of the user. For instance, the social network can be Twitter, and the one or more other users/members of Twitter can be one or more “followers” of the user.

In one or more embodiments, CD 1171 can provide the message from the user to the one or more other users/members of the social network utilizing one or more communication means. For example, CD 1171 can provide the message from the user to the one or more other users/members of the social network via one or more of a short message service (SMS) message, an electronic mail message, a posting to a user's web page (e.g., posting to a user's “Wall” in Facebook), a RSS (really simple syndication) feed, and a network communication to an APP of a user's CD (e.g., a “push” message), among others. In one instance, CD 1171 can provide the message from the user of CD 1110 to the user of CD 1111 via a SMS message. In a second instance, CD 1171 can provide the message from the user of CD 1110 to the user of CD 1130 via an electronic mail message.

In one or more embodiments, the message provided to the one or more other users/members of the social network can include or can be augmented by CD 1170 with the account identifier. The one or more other users/members of the social network can utilize the account identifier to view items from the account associated with the user of CD 1110. This can allow the one or more other users/members of the social network to repeat or not repeat items from the account. In one example, the items from the account can include multiple drinks of a specific type and/or brand, and the one or more other users/members of the social network can purchase another drink for the user of CD 1110 that corresponds to the specific type and/or brand. In another example, the items from the account can include an indication of a dinner plate, and the one or more other users/members of the social network can purchase a desert for the user of CD 1110 rather than another dinner plate.

In one or more embodiments, each of multiple users can use the account identification to purchase his or her share of multi-party tab or bill. In this fashion, the tab or bill can be separated. For example, multiple users (e.g., multiple co-workers) can patronize a restaurant for lunch. At least two of the multiple users can access and/or utilize the account identifier to view the tab or bill and/or apply money to at least two different portions of the tab or bill. For instance, a user of CD 1111 can access and/or utilize the account identifier to view the tab or bill and/or apply a first amount of money to tab or bill, and a user of CD 1112 can access and/or utilize the account identifier to view the tab or bill and/or apply a second amount of money to tab or bill. The second amount of money can be equal to the first amount of money, or the second amount of money can be not equal to the first amount of money.

As shown, a business associate, utilizing CD 1113 (e.g., a POS terminal), can add a good or a service to the user's account. For instance, business associate can add one or more of a drink, a meal, and a massage, among others, to the user's account.

Referring now to FIG. 5B, CD 1111 can display the message, from the user of CD 1110, to the user of CD 1111, and CD 1130 can display the message to the user of CD 1130. In one or more embodiments, displaying the message to the user of CD 1130 can be replaced or augmented with conveying, in an audible or audio fashion, the message to the user of CD 1130. For example, CD 1130 can include a text-to-speech functionality that can be utilized to conveying, in an audible or audio fashion, the message to the user of CD 1130.

In one or more embodiments, displaying the message to the user of CD 1130 can include displaying one or more goods and/or services for sale by the business. In one example, a drink menu (e.g., a drink list with corresponding prices) can be displayed to the user of CD 1130. In a second example, a food menu (e.g., a food list with corresponding prices) can be displayed to the user of CD 1130. In another example, a service menu (e.g., a service list with corresponding prices) can be displayed to the user of CD 1130. In one or more embodiments, the user of CD 1130 can select from a menu associated with the business and/or provide an amount of money towards the account associated with the user of CD 1110.

In one example, the amount of money towards the account associated with the user of CD 1110 can include a range of amounts with an upper limit. For instance, the user of CD 1130 can select purchasing a good or a service for the user of CD 1110 that can cost up to ten dollars ($10). As illustrated, CD 1130 can provide payment information to CD 1170. In one or more embodiments, the payment information can include one or more of a menu selection, an amount of money to be applied towards the account associated with the user of CD 1110, and payment account information (e.g., a credit card number, a debit card number, a PayPal account number, etc.).

As illustrated, CD 1170 can provide payment information to CD 1113. In one or more embodiments, the payment information provided to CD 1113 can include one or more of a menu selection, an amount of money to be applied towards the account associated with the user of CD 1110, and payment account information e.g., a credit card number, a debit card number, a PayPal account number, etc.). If the payment is successful, CD 1113 can provide CD 1170 with a successful acknowledgement, as shown. As illustrated, CD 1170 can provide CD 1130 with a successful acknowledgement indicating that the one or more goods and/or the services were successfully purchased for the user of CD 1110 and/or indicating that the amount of money was successfully applied to the account associated with the user of CD 1110. In one or more embodiments, the acknowledgement provided to CD 1130 can include a receipt indicating that the one or more goods and/or the services were successfully purchased for the user of CD 1110 and/or indicating that the amount of money was successfully applied to the account associated with the user of CD 1110. For example, the receipt can be used for business and/or tax purposes.

As shown, CD 1170 can provide, to the social network via CD 1171, information indicating that the user of CD 1130 successfully purchased the one or more goods and/or the services for the user of CD 1110 and/or indicating that the amount of money was successfully applied to the account associated with the user of CD 1110. In one or more embodiments, the information provided to the social network can be provided to one or more “friends” and/or “followers” of the user of CD 1110. As illustrated, CD 1170 can provide, to the user of CD 1110, information indicating that the user of CD 1130 successfully purchased the one or more goods and/or the services for the user of CD 1110 and/or indicating that the amount of money was successfully applied to the account associated with the user of CD 1110.

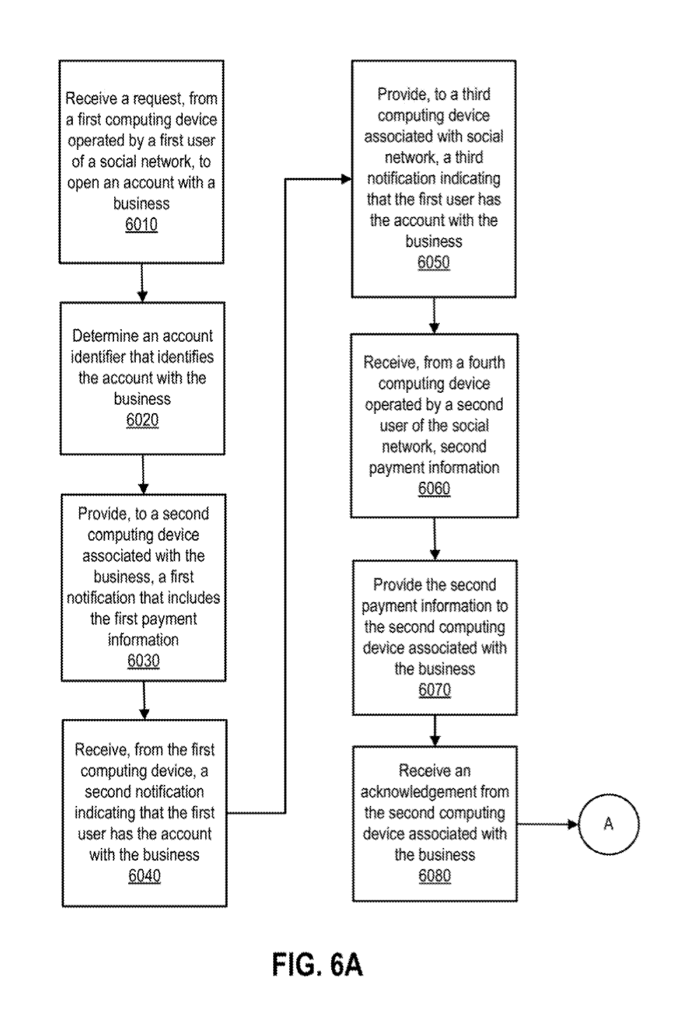

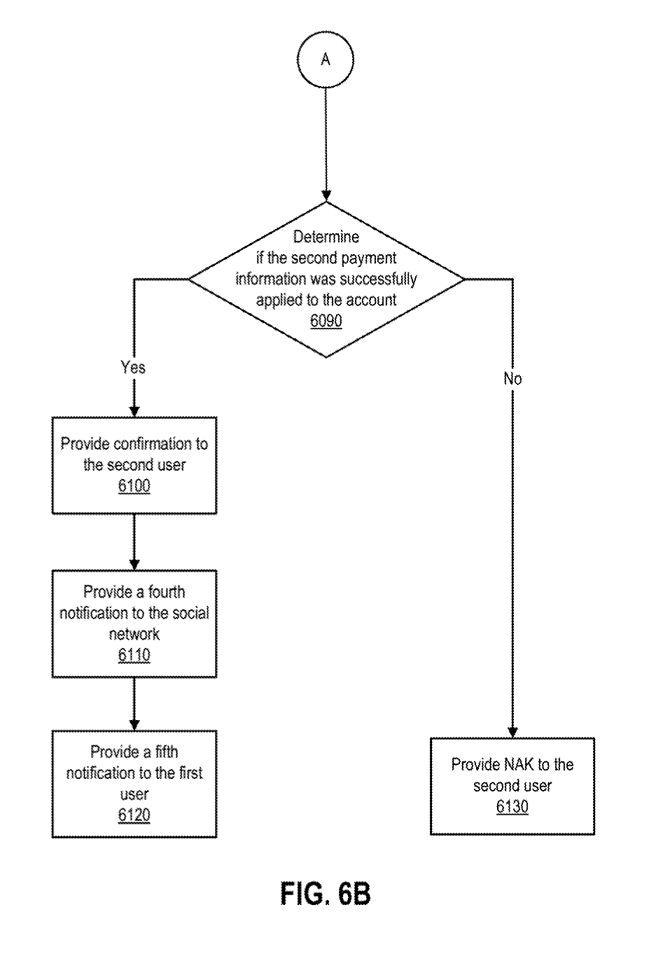

Turning now to FIGS. 6A and 6B, a method of operating a coordination computing device is illustrated, according to one or more embodiments. At 6010, a request, from a first computing device operated by a first user of a social network, to open an account with a business can be received. For example, CD 1170 can receive the request from CD 1110.

In one or more embodiments, the request can include one or more of a user ID, authentication information (e.g., a password), first payment information (e.g., a credit card number, a debit card number, a PayPal account number, etc.), and business identification information. In one or more embodiments, the business identification information can include a name of the business (e.g., “Dave's Bar”, “Highland Grill”, “Pelican Hotel”, “the Sterling Hotel Austin”, “the Sterling Hotel Dallas”, etc.), an address of the business location (e.g., a street name, a street number, a city, a state, a zip code, etc.), coordinates of the business location (e.g., a latitude number and a longitude number), a string of characters, and a number (e.g., an index number of a row in a database), among others.

At 6020, an account identifier that identifies the account with the business can be determined. In one example, CD 1170 can determine the account identifier. For instance, CD 1170 can determine a string of characters that can be used as the account identifier and that can be input into a keyboard of a POS terminal of the business and/or displayed via a display of CD 1110. In one or more embodiments, CD 1170 can, in determining the account identifier, communicate with CD 1113 to determine that the account identifier can be used to identify the account with the business.

For example, CD 1170 can confirm with CD 1113 that the account identifier is sufficient and/or unobjectionable to be utilized to identify the account with the business. If CD 1170 does not confirm with CD 1113 that the account identifier is sufficient and/or unobjectionable to be utilized to identify the account with the business, another account identifier can be determined, and CD 1170 can confirm with CD 1113 that the other account identifier is sufficient and/or unobjectionable to be utilized to identify the account with the business. In one or more embodiments, CD 1170 can continue to negotiate with CD 1113 a number of times or until an account identifier is determined as sufficient and/or unobjectionable to be utilized to identify the account with the business.

At 6030, a first notification that includes the first payment information associated with the first user and the account identifier that identifies the account can be provided to the business. For example, CD 1170 can provide the first notification that includes the first payment information and the account identifier to CD 1113.

At 6040, a second notification indicating that the first user of the social network has the account with the business and at the location of the business can be received from the first computing device operated by the first user. For example, CD 1170 can receive the second notification from CD 1110. In one or more embodiments, the second notification can include a first message that can include location information associated with the business and/or text that can be shared with one or more other users of the social network to which the first user is socially coupled via the social network. In one example, the first message can include text such as “It's happy hour! Come join me at Dave's Bar.”, “It's my birthday! Come join me at Highland Grill.”, or “I'm in Austin! Come join me at the Pelican Hotel.”, among others. For instance, location information and/or the text of the first message can be shared with one or more “friends” and/or “followers” of the first user. In another example, the first message can include information indicating location 1210. For instance, the information indicating location 1210 can include one or more of a name of the business (e.g., “Dave's Bar”, “Highland Grill”, “Pelican Hotel”, “Sterling Hotel Austin”, “Sterling Hotel Dallas”, etc.), an address of the business location (e.g., a street name, a street number, a city, a state, a zip code, etc.), and coordinates of the business location (e.g., a latitude number and a longitude number), among others.

At 6050, a third notification indicating that the first user of the social network has the account with the business can be provided to the social network. For example, CD 1170 can provide the third notification to CD 1171. In one or more embodiments, the third notification can include the first message included in the second notification. For example, CD 1170 can provide the first message included in the second notification to CD 1171 using an application programming interface (API). For instance, the API can be provided and/or published by the social network to allow the first user of the social network to utilize a system (e.g., CD 1170) different from the social network to communicate one or more messages to one or more other users of the social network.

At 6060, second payment information associated with a second user of the social network can be received. For example, CD 1170 can receive the second payment information from CD 1130. For instance, the one or more other users of the social network to which the first user is socially coupled via the social network can include the second user. In one or more embodiments, the second payment information can include one or more of a menu selection, an amount of money to be applied towards the account, and payment account information (e.g., a credit card number, a debit card number, a PayPal account number, etc.).

At 6070, the second payment information can be provided to the business to be applied to the account. For example, CD 1170 can provide the second payment information to CD 1113. At 6080, acknowledgement information can be received. For example, CD 1170 can receive the acknowledgement information from CD 1113. In one instance, the acknowledgement information can indicate that the second payment information was successfully applied to the account. In another instance, the acknowledgement information can include a negative acknowledgement (NAK) indicating that the second payment information was not successfully applied to the account. In one example, the account can be closed when the second payment information is applied to the account. In another example, a use of the payment account information can indicate that the payment account information has nonsufficient funds (NSF) or a lack of sufficient available credit.

At 6090, it can be determined if the second payment information was successfully applied to the account. If the second payment information was successfully applied to the account, a confirmation that the payment account information was applied to the account can be provided to the second user, at 6100. For example, CD 1170 can provide the confirmation that the payment account information was applied to the account to CD 1130. At 6110, a fourth notification can be provided to the social network. For example, CD 1170 can provide the fourth notification to CD 1171. In one instance, the fourth notification can include a second message indicating that the second user purchased one or more goods and/or one or more services, for sale by the business, for the first user. For example, this second message can be conveyed to other users of the social network (e.g., other “friends” or “followers” of the first user). In another instance, the fourth notification can include a second message indicating that the second user applied an amount of money to the account.

At 6120, a fifth notification can be provided to the first user. For example, CD 1170 can provide the fifth notification to CD 1110. In one instance, the fifth notification can include a third message indicating that the second user purchased one or more goods and/or one or more services, for sale by the business, for the first user. In another instance, the fifth notification can include a third message indicating that the second user applied an amount of money to the account.

If the second payment information was not successfully applied to the account, a NAK can be provided to the second user, at 6130. For example, CD 1170 can provide the NAK to CD 1130. For instance, the NAK can include NAK information indicating that the second payment information was not successfully applied to the account. In one example, the account can be closed when the second payment information is applied to the account. In another example, a use of the payment account information can indicate that the payment account information has NSF or a lack of sufficient available credit.

In one or more embodiments, one or more method elements can be repeated using a different user of the social network. For example, the social network can provide the message included in the third notification to multiple users of the social network that are socially coupled to the first user (e.g., “friends” of the first user, “followers” of the first user, etc.). For instance, one or more of method elements 6060-6130 can be performed, in a repetition, using a third user of the multiple users of the social network that are socially coupled to the first user, where the third user is different from the second user and the first user and where the third user can be associated with a fifth computing device (e.g., a CD of CDs 1111, 1112, 1120-1122, and 1140) and can provide third payment information associated with the third user.

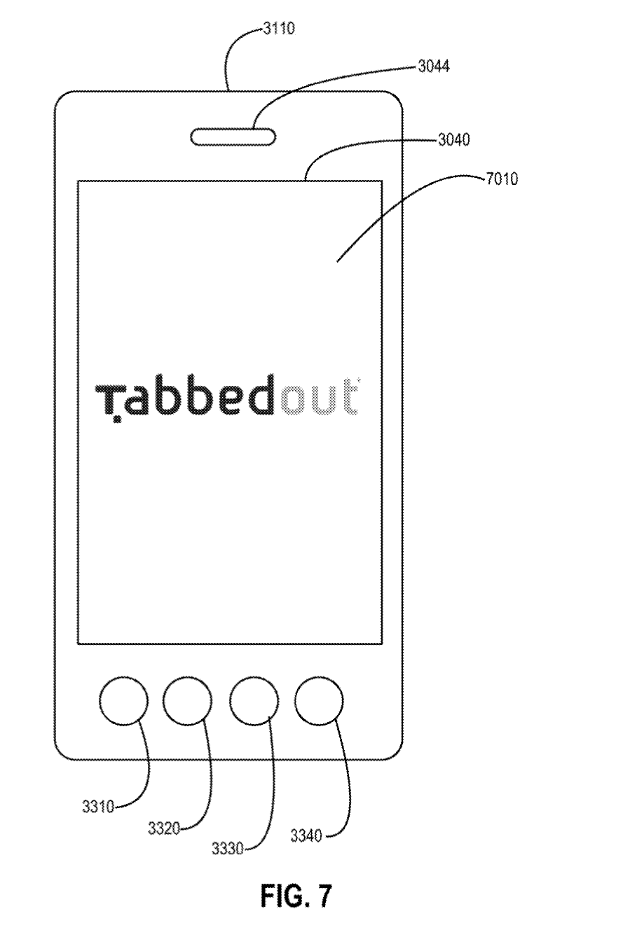

Turning now to FIG. 7, an exemplary diagram of a mobile device and a display window or display area of a mobile device application is illustrated, according to one or more embodiments. As illustrated, display 3040 can display a display area or window 7010. For example, APP 3070 can display information via display 3040 and display area or window 7010. For example, display area or window 7010 can include a graphical user interface (GUI). In one or more embodiments, MD 3110 can include one or more buttons or momentary switches 3310-3340 that can be actuated by a user to provide user input to MD 3110.

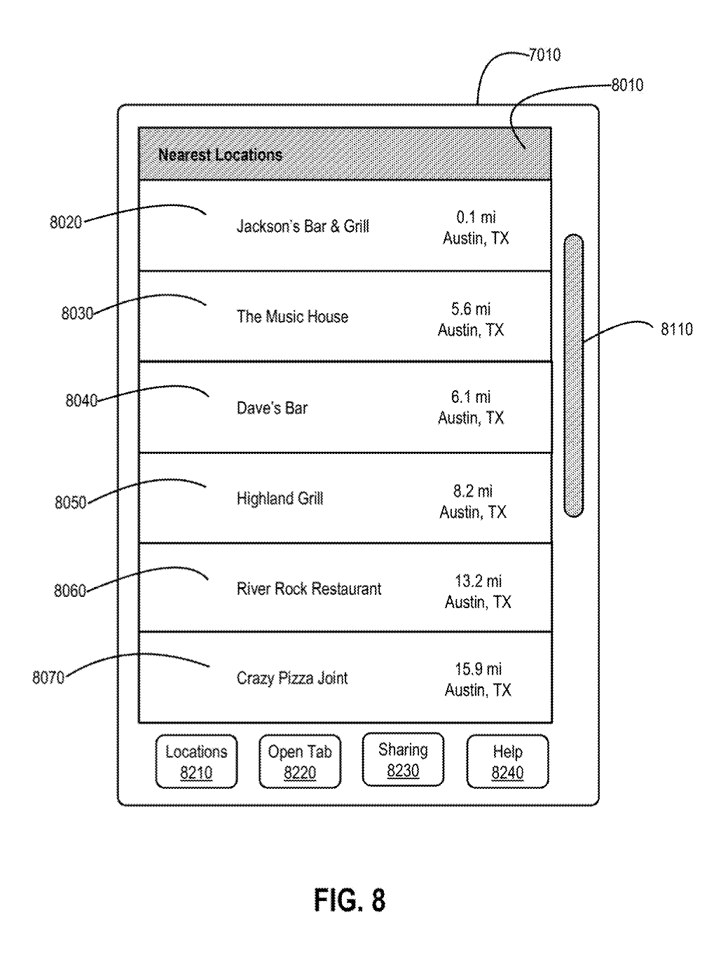

Turning now to FIGS. 8-13, exemplary block diagrams of various user interfaces of a mobile device application are illustrated, according to one or more embodiments. As illustrated in FIG. 8, display area or window 7010 can display one or more information elements 8010-8070. For example, information elements 8020-8070 can convey respective names of businesses and/or locations of businesses. In one or more embodiments, an information element (e.g., an information element of information elements 8020-8070) can be selected to provide further information associated with a business and/or a location of the business. As shown, display area or window 7010 can display a scroll bar 8110 that can be used to display more information elements.

As shown, display area or window 7010 can display one or more buttons or icons 8210-8240. In one example, icon 8210 can be selected to display one or more information elements to convey respective names of businesses and/or locations of businesses. In a second example, icon 8220 can be selected to provide, to CD 1170, a request to open an account with a business. In a third example, icon 8230 can be selected to provide, to CD 1170, the second notification indicating that the first user of the social network has the account with the business. In another example, icon 8240 can be selected to receive aid and/or help in operating and/or utilizing APP 3070.

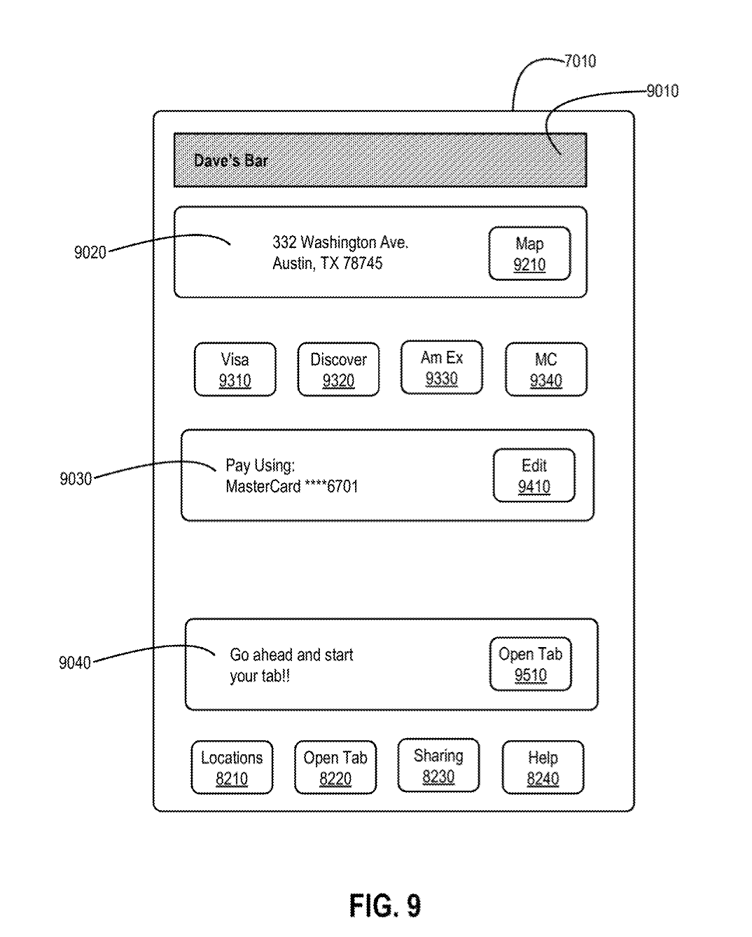

As illustrated in FIG. 9, display area or window 7010 can display one or more information elements 9010-9040. For example, information element 9010 can indicate that “Dave's Bar” has been selected. For instance, information element 9010 can indicate that information element 8040 has been selected. As shown, information element 9020 can indicate a location of a business such as a street number, a street name, a city, state, and a zip code. In one or more embodiments, button or icon 9210 can be selected by a user to display a map that indicates the location of the business. For example, the map can indicate location 1210.

As illustrated, buttons or icons 9310-9340 can be displayed to indicate one or more credit cards that can be utilized at the business. For example, an icon of icons 9310-9340 can be selected by a user to respectively utilize a Visa credit card, a Discover credit card, an American Express credit card, and a MasterCard credit card. In one or more embodiments, a debit card can be utilized. For example, icon 9310 can be selected to utilize a Visa debit card that draws from a user's checking account.

As shown, information element indicates that a MasterCard credit card (ending in 6701) has been selected for use. In one or more embodiments, button or icon 9410 can be selected to edit information associated with the selected card or to select a different card. In one example, a user can select icon 9410 to edit a number (e.g., a credit card number, a debit card number, etc.) associated with the selected card. In a second example, a user can select icon 9410 to edit an expiration date associated with the selected card. In another example, a user can select icon 9410 to select another card for use.

As illustrated, information element 9040 can indicate that an account (e.g., a tab) with the business and at the location of the business can be opened and/or created. As shown, button or icon 9510 can be selected to open and/or create an account (e.g., a tab) with the business and at the location of the business.

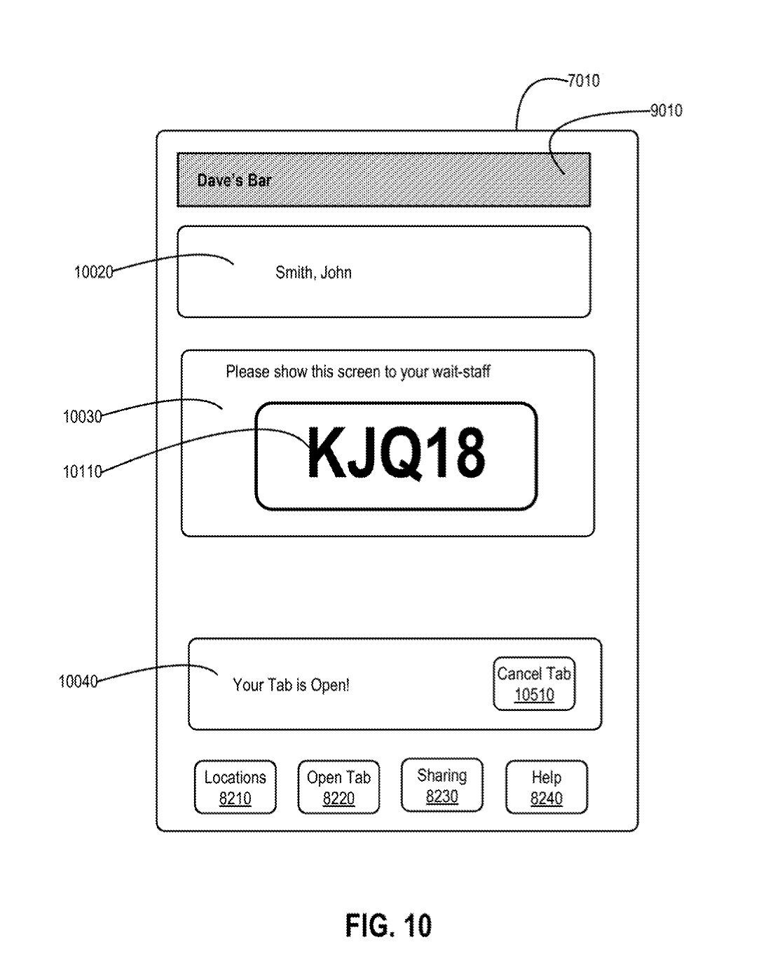

As illustrated in FIG. 10, display area or window 7010 can display one or more information elements 10020-10040. As shown, information element 10020 can indicate a name, screen name, and/or username of a user of MD 3110. In one or more embodiments, information element 10020 can convey an account identifier 10110 that identifies the account (e.g., tab) with the business and at the location of the business. For example, account identifier 10110 can include a string of characters such as “KJQ18” in this example. For instance, account identifier 10110 can be conveyed to a person of the wait-staff of the business (e.g., a bartender, a waitress, a waiter, concierge, etc.) so that the wait-staff can debit one or more goods and/or one or more services to the account (e.g., tab). In one or more embodiments, account identifier 10110 can be shared with other users of other computing devices so that the other users can share payment of the account or tab. In one or more embodiments, button or icon 10510 can be selected to cancel the account or tab. For example, the account or tab may have been erroneously opened. For instance, the account or tab can be canceled if nothing has been debited to the account or tab.

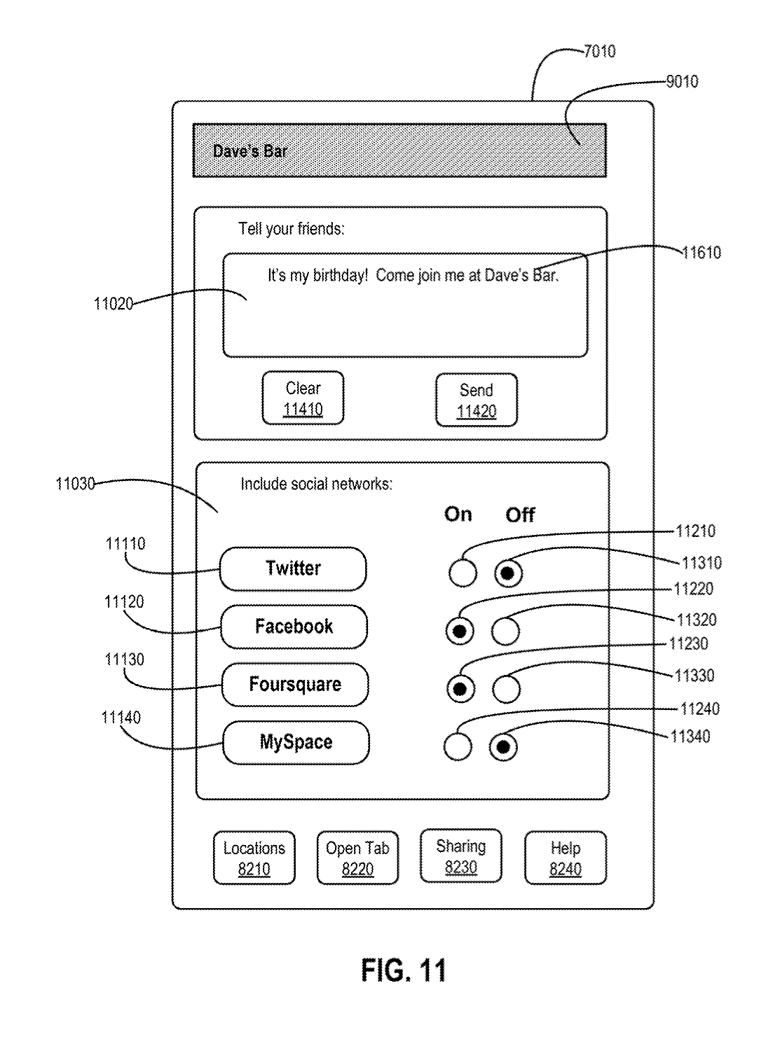

As illustrated in FIG. 11, display area or window 7010 can display one or more user input/output elements 11020 and 11030. As shown, a text input area 11020 can be displayed, and a user can input text into text input area 11020. For example, the user can input a message that can be provided to one or more others users of a social network to which the user is socially coupled. As illustrated, the user can input text 11610 (e.g., “It's my birthday! Come join me at Dave's Bar.”). In one or more embodiments, a button or icon 11410 can be selected by the user to clear any text included in text input area 11020, and a button or icon 11420 can be selected by the user to provide text 11610 to one or more others users of one or more social networks to which the user is socially coupled.

As shown, input/output menu 11030 can convey social network information associated with providing text 11610 to one or more others users of one or more social networks to which the user is socially coupled. For example, input/output menu 11030 can include one or more information elements 11110-11140 that can convey respective social network identifications and/or names “Twitter”, “Facebook”, “Foursquare”, and “MySpace”. In one or more embodiments, one or more inclusion elements 11210-11240 can indicate and/or be selected to include providing text 11610 to respective social networks indicated by information elements 11110-11140 respectively, and one or more exclusion elements 11310-11340 can indicate and/or be selected to not provide text 11610 to respective social networks indicated by information elements 11110-11140 respectively. In one example, inclusion element 11210 and exclusion element 11310 can be combined into a graphical switch to either include or exclude text 11610 as being provided to the social network indicated via information element 11110.

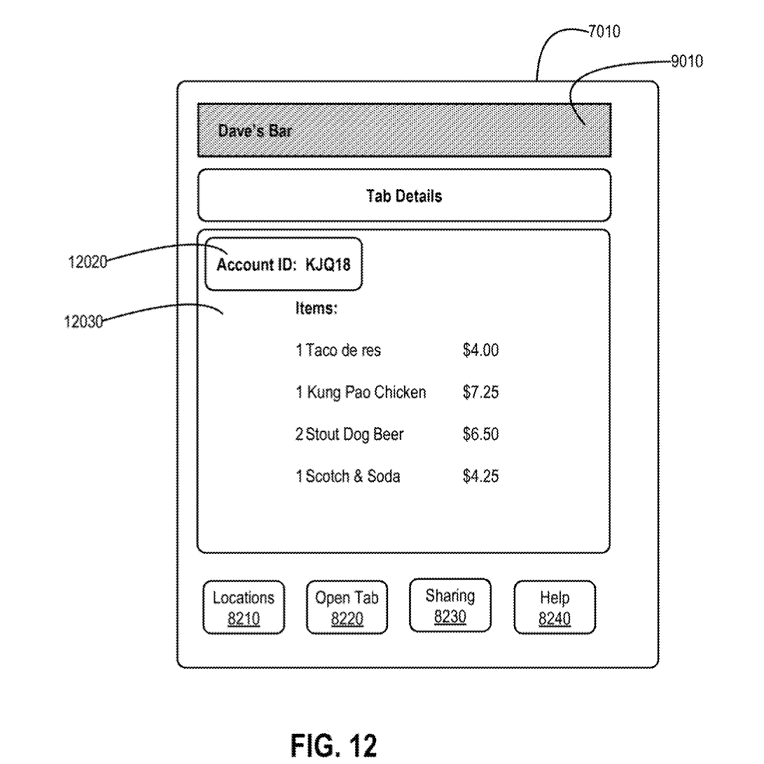

As illustrated in FIG. 12, display area or window 7010 can display one or more information elements 12020 and 12030. In one example, information element 12020 can indicate an account identifier. In another example, information element 12030 can indicate a list of items charged to the account with the business.

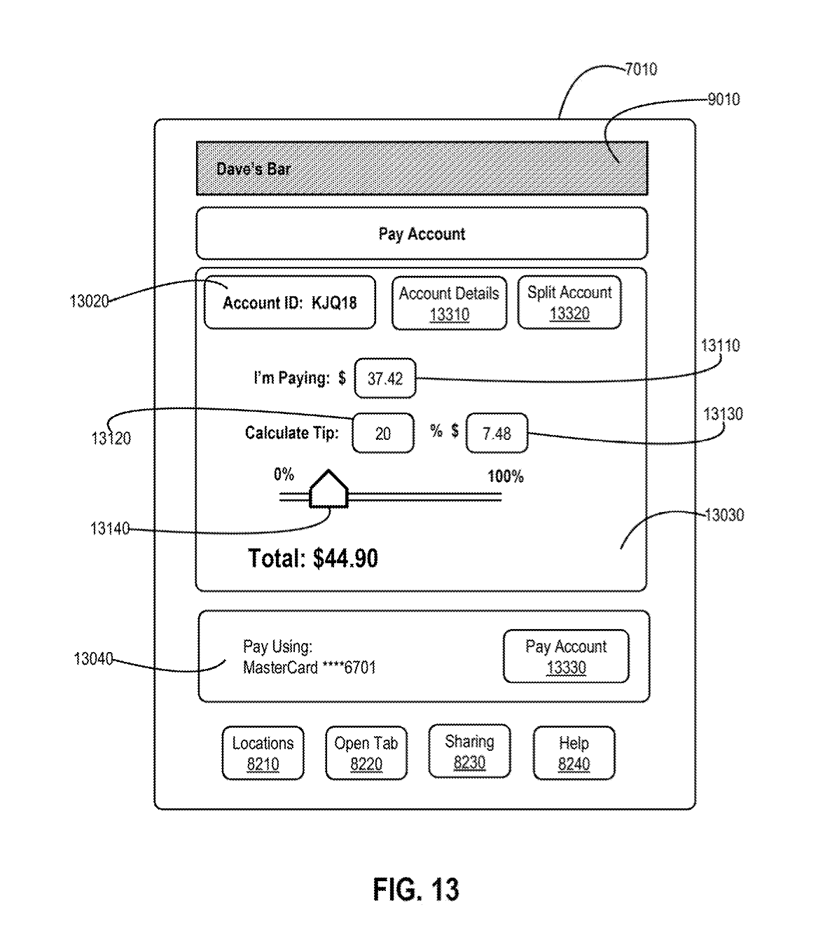

With reference now to FIG. 13, display area or window 7010 can display one or more information elements 13020-13040. As illustrated, information element 13020 can convey an account identification, information element 13030 can convey an amount and a tip to be paid, and information element 13040 can convey a payment method.

In one or more embodiments, an amount to be paid can be displayed and/or can be conveyed via an input/output element 13110. For example, the user can input an amount of 37.42 dollars via input/output element 13110. In one or more embodiments, a tip percentage can be displayed and/or can be conveyed via an input/output element 13120, and an amount of tip to be paid can be displayed and/or can be conveyed via an information element 13130. In one example, the user can input twenty (20) for twenty percent (20%) via input/output element 13120, and an amount of tip to be paid can be calculated and can be displayed and/or can be conveyed via information element 13130. In a second example, the user can utilize a slider element 13140 to select a tip percentage; the tip percentage can be can be displayed and/or can be conveyed via input/output element 13120; and an amount of tip to be paid can be calculated and can be displayed and/or can be conveyed via information element 13130.

As shown, information element 13040 can convey and/or display a payment method (e.g., a MasterCard ending in “6701”). In one or more embodiments, a button or icon 13330 can be selected by the user to pay the account with the amount conveyed via input/output element 13110 and the amount conveyed via information element 13130 using the payment method conveyed via information element 13040.

In one or more embodiments, button or icon 13310 can be selected by the user to show details associated with the account. For example, icon 13310 can be selected by the user and APP 3070 can display account details in accordance with those conveyed via information element 12030 of FIG. 12. In one or more embodiments, button or icon 13320 can be selected by the user to split the account. For example, splitting the account can include providing the account identification to one or more other mobile devices. In one instance, MD 3110 can provide the account identification to one or more of CDs 1111 and 1112.

In one or more embodiments, one or more communications via one or more networks can include using a secure method, process, and/or system. For example, a communication via at least one network can include utilizing a secure socket layer (SSL), transport layer security (TLS), a virtual private network (VPN) connection, an encrypted tunnel, encrypted messaging, and IPSec (Internet protocol security), among others.

In one or more embodiments, the term “memory medium” can mean a “memory” and/or “tangible computer readable medium” which is intended to include various types of memory or storage, including an installation medium, e.g., a CD-ROM, or floppy disks, a random access memory or computer system memory such as DRAM, SRAM, EDO RAM, Rambus RAM, NVRAM, EPROM, EEPROM, flash memory etc., and/or a non-volatile memory such as a magnetic media, e.g., a hard drive, and/or optical storage. The memory medium can include other types of memory as well, or combinations thereof. In one or more embodiments, the memory medium can be and/or include an article of manufacture and/or a software product that stores instructions executable by a processor in implementing one or more methods and/or processes described herein. In addition, the memory medium can be located in a first computer in which the programs are executed, or can be located in a second different computer and/or hardware memory device that connects to the first computer over a network. In one or more embodiments, the second computer provides the program instructions to the first computer for execution. The memory medium can also be a distributed memory medium, e.g., for security reasons, where a portion of the data is stored on one memory medium and the remaining portion of the data can be stored on a different memory medium. Also, the memory medium can include one of the networks to which the current network is coupled, e.g., a SAN (Storage Area Network), a NAS (Network Area Storage), a NFS (Network File System), etc.

In one or more embodiments, each of the systems described herein may take various forms, including a personal computer system, server computer system, workstation, network appliance, Internet appliance, wearable computing device, PDA, laptop, mobile telephone, mobile multimedia device, embedded computer system, television system, and/or other device. In general, the terms “computing device”, “computer”, and/or “computer system” can be broadly defined to encompass any device having a processor which executes instructions from a memory medium. A CPU or processing unit in one or more systems executing code and data from a memory medium includes a means for executing one or more software program according to the methods and/or flowcharts described herein.

It is noted that, in one or more embodiments, one or more of the method elements described herein and/or one or more portions of an implementation of a method element can be performed in varying orders, can be repeated, can be performed concurrently with one or more of the other method elements and/or one or more portions of an implementation of a method element, or can be omitted. Additional and/or duplicated method elements can be performed as desired. For example, a process and/or method can perform one or more described method elements concurrently with duplicates of the one or more described method elements. For instance, multiple methods, processes, and/or threads can be implemented using same described method elements.

In one or more embodiments, concurrently can mean simultaneously. In one or more embodiments, concurrently can mean apparently simultaneously according to some metric. For example, two or more method elements and/or two or more portions of an implementation of a method element can be performed such that they appear to be simultaneous to a human. It is also noted that, in one or more embodiments, one or more of the system elements described herein may be omitted and additional system elements can be added as desired.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of a claimed invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description. Changes may be made in the elements described herein without departing from the spirit and scope of the invention as described in the following claims.

What is claimed is:

1. A method, comprising:
receiving, from a first computing device operated by a first user of a social network, a request to open an account with a business;
providing, to a second computing device associated with the business, a first notification that includes first payment information associated with the first user and an account identifier that identifies the account;
receiving, from the first computing device operated by the first user of the social network, a second notification indicating that the first user of the social network has the account with the business;
providing, to a third computing device associated with the social network, a third notification indicating that the first user of the social network has the account;
receiving, from a fourth computing device operated by a second user of the social network, second payment information associated with the second user; and
providing, to the business, the second payment information to be applied to the account.

2. The method of claim 1, further comprising:
providing, to the second user of the social network, at least one of a confirmation that the payment information was applied to the account and a negative acknowledgement indicating the payment information was not applied to the account.

3. The method of claim 1, wherein the second payment information includes an amount of money.

4. The method of claim 1, wherein the second payment information indicates at least one of a good offered for sale by the business and a service offered for sale by the business.

5. The method of claim 1,
wherein the first user is at a location associated with the business;
wherein said providing, to the third computing device associated with the social network, the third notification indicating that the first user of the social network has the account includes digitally signaling to a plurality of users of the social network, to which the first user is socially coupled, a message indicating that the first user is at the location associated with the business; and
wherein the plurality of users of the social network includes the second user.

6. The method of claim 5, wherein the message indicating that the first user is at the location associated with the business includes a name associated with the location.

7. The method of claim 5, wherein the message indicating that the first user is at the location associated with the business includes at least one of a location of a bar, a location of a restaurant, and a location of a retail establishment.

8. The method of claim 1, wherein at least one of the second computing device operated by the first user and the fourth computing device operated by the second user is a mobile computing device.

9. The method of claim 1, wherein the fourth computing device operated by the second user is at a different location from a location associated with the business.

10. The method of claim 1, wherein the fourth computing device operated by the second user is at a location associated with the business.

11. A system, comprising:
a processor; and
a memory coupled to the processor;
wherein the memory stores instructions which when executed by the processor the system receives, from a first computing device operated by a first user of a social network, a request to open an account with a business; provides, to a second computing device associated with the business, a first notification that includes first payment information associated with the first user and an account identifier that identifies the account; receives, from the first computing device operated by the first user of the social network, a second notification indicating that the first user of the social network has the account with the business; provides, to a third computing device associated with the social network, a third notification indicating that the first user of the social network has the account; receives, from a fourth computing device operated by a second user of the social network, second payment information associated with the second user; and
provides, to the business, the second payment information to be applied to the account.

12. The system of claim 11, wherein the instructions which when executed by the processor, the system further provides, to the second user of the social network, at least one of a confirmation that the second payment information was applied to the account and a negative acknowledgement indicating the second payment information was not applied to the account.

13. The system of claim 11, wherein the second payment information includes an amount of money.

14. The system of claim 11, wherein the second payment information indicates at least one of a good offered for sale by the business and a service offered for sale by the business.

15. The system of claim 11,
wherein the first user is at a location associated with the business;
wherein when the system provides, to the third computing device associated with the social network, the third notification indicating that the first user of the social network has the account, the system digitally signals to a plurality of users of the social network, to which the first user is socially coupled, a message indicating that the first user is at the location associated with the business; and
wherein the plurality of users of the social network includes the second user.

16. The system of claim 15, wherein the message indicating that the first user is at the location associated with the business includes a name associated with the location.

17. The system of claim 15, wherein the message indicating that the first user is at the location associated with the business includes at least one of a location of a bar, a location of a restaurant, and a location of a retail establishment.

18. The system of claim 11, wherein at least one of the second computing device operated by the first user and the fourth computing device operated by the second user is a mobile computing device.

19. The system of claim 11, wherein the fourth computing device operated by the second user is at a different location from a location associated with the business.

20. The system of claim 11, wherein the fourth computing device operated by the at least the second user is at a location associated with the business.

21. A computer readable memory device comprising instructions, which when executed by a processor of a processing system, the processing system receives, from a first computing device operated by a first user of a social network, a request to open an account with a business; provides, to a second computing device associated with the business, a first notification that includes first payment information associated with the first user and an account identifier that identifies the account; receives, from the first computing device operated by the first user of the social network, a second notification indicating that the first user of the social network has the account with the business; provides, to a third computing device associated with the social network, a third notification indicating that the first user of the social network has the account; receives, from a fourth computing device operated by a second user of the social network, second payment information associated with the second user; and provides, to the business, the second payment information to be applied to the account.

22. The computer readable memory device of claim 21, wherein the instructions which when executed by the processor, the processing system further provides, to the second user of the social network, at least one of a confirmation that the payment information was applied to the account and a negative acknowledgement indicating the payment information was not applied to the account.

23. The computer readable memory device of claim 21, wherein the second payment information includes an amount of money.

24. The computer readable memory device of claim 21, wherein the second payment information indicates at least one of a good offered for sale by the business and a service offered for sale by the business.

25. The computer readable memory device of claim 21,
wherein the first user is at a location associated with the business;
wherein when the system provides, to the third computing device associated with the social network, the third notification indicating that the first user of the social network has the account, the system digitally signals to a plurality of users of the social network, to which the first user is socially coupled, a message indicating that the first user is at the location associated with the business; and
wherein the plurality of users of the social network includes the second user.

26. The computer readable memory device of claim 25, wherein the message indicating that the first user is at the location associated with the business includes a name associated with the location.

27. The computer readable memory device of claim 25, wherein the message indicating that the first user is at the location associated with the business includes at least one of a location of a bar, a location of a restaurant, and a location of a retail establishment.

28. The computer readable memory device of claim 21, wherein at least one of the second computing device operated by the first user and the fourth computing device operated by the second user is a mobile computing device.

29. The computer readable memory device of claim 21, wherein the fourth computing device operated by the second user is at a different location from a location associated with the business.

30. The computer readable memory device of claim 21, wherein the fourth computing device operated by the at least the second user is at a location associated with the business.
